(19) United States
(12) Patent Application Publication
(10) Pub. No.: US 2005/0041631 A1
(43) Pub. Date: Feb. 24, 2005

(54) Apparatus and method for primary link packet control

(76) Inventors: Naveen Aerrabotu, Gurnee, IL (US); Mark E. Pecen, Palatine, IL (US); Chris J. Venteicher, Williams Bay, WI (US)

Correspondence Address: MOTOROLA INC, 600 NORTH US HIGHWAY 45, ROOM AS437, LIBERTYVILLE, IL, 60048-5343, US

(21) Appl. No.: 10/644,297

(22) Filed: Aug. 20, 2003

(51) Int. Cl. H04J 3/24

(52) U.S. Cl. 370/349

(57) ABSTRACT

An apparatus and method for primary link packet control using a traffic flow template. Primary link traffic flow template filter parameters can be set at a packet control module. Incoming packet data can be compared against the primary link traffic flow template filter parameters. How the incoming packet data is sent to the wireless device over the primary link can be controlled based on comparing incoming packet data against the primary link traffic flow template filter parameters.

### BACKGROUND

1. Field

The present disclosure is directed to an apparatus and method for primary link packet control. In particular, the present disclosure is directed to an apparatus and method for primary link packet control using a traffic flow template.

2. Description of Related Art

Presently, a user of a wireless device can obtain an initial wireless connection to a wireless network by establishing a primary link such as a primary context. At least one additional connection can be established on a secondary link such as a secondary context. After obtaining a wireless connection, the user can receive messages at the wireless device from the wireless network. These messages can include short messaging service messages, PUSH messages, or any other packet data. For example, wireless access protocol push technology allows users of the service to be pushed data from a network to their wireless device. Initially, to set up the service, a user can browse a website that is hosted by a push initiator who offers a service desired by the user. Such services can include weather updates, sports updates, or any other data that can be pushed to a wireless device. After setting up the service, the user can automatically receive data from a push initiator.

Unfortunately, undesired data may be sent to a user's wireless device over a primary link wireless connection. For example, packet data that is preferably sent over a different link or to a different device may be sent to the wireless device over the primary link. Also, unsolicited advertisement messages, viruses, or the like may be sent to the wireless device. While the wireless device may be able to purge some packet data and wireless messages, the undesired packet data and the unsolicited messages consume valuable wireless network resources. For example, increasing amounts of unwanted and un-trusted packet-based data can cause wireless resource wastage and can cause wireless network overloading. This can become a bigger problem for wireless devices that use an always on methodology where a continuous connection exists between the wireless device and the wireless network on the primary link for a longer period of time.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a system according to one embodiment;

FIG. 2 is an exemplary block diagram of a wireless device according to one embodiment;

FIG. 3 is an exemplary flowchart outlining the operation of a traffic flow template control module according to one embodiment;

FIG. 4 is an exemplary flowchart outlining the operation of a wireless device according to one embodiment; and

FIG. 5 is an exemplary message flow diagram according to one embodiment.

### DETAILED DESCRIPTION OF PREFERRED EMBODIMENTS

The disclosure provides an apparatus and method for primary link packet control using a traffic flow template. According to one embodiment, primary link traffic flow template filter parameters can be set at a packet control module. Incoming packet data can be compared against the primary link traffic flow template filter parameters. How the incoming packet data is sent to the wireless device over the primary link can be controlled based on comparing incoming packet data against the primary link traffic flow template filter parameters.

According to another embodiment, a primary packet data protocol link request message including a traffic flow template information element can be sent to a network. A primary packet data protocol link acknowledgement including an Internet protocol address can be received from the network.

According to another embodiment, a network gateway can include a packet data protocol primary link information module. The packet data protocol primary link information module can include traffic flow template information related to controlling which packets of data are sent to a wireless device on a primary link. The network gateway can also include a traffic flow template packet control module coupled to the packet data protocol primary link information module. The traffic flow template packet control module can be configured to control which packets of data are sent to a wireless device on the primary link based on the traffic flow template information.

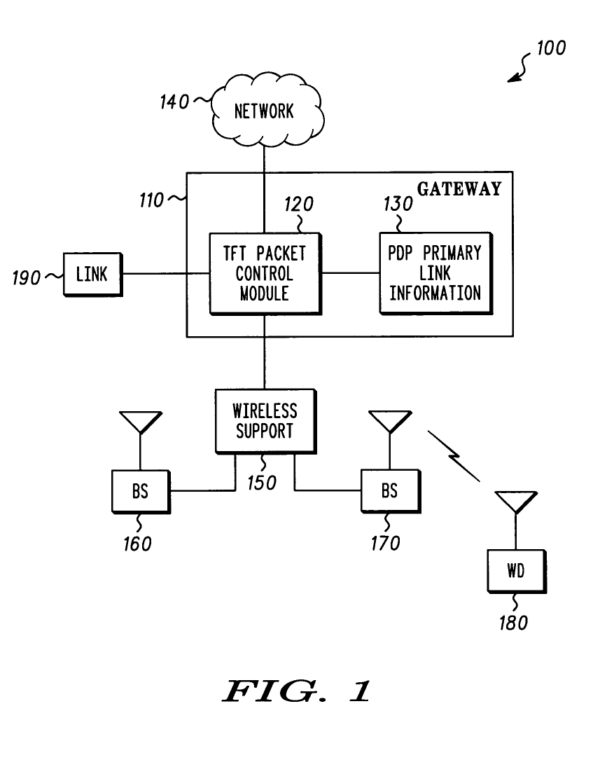

FIG. 1 is an exemplary block diagram of a system 100 according to one embodiment. The system 100 can include a gateway 110, a traffic flow template packet control module 120, a packet data protocol primary link information module 130, a network 140, a wireless support module 150, base stations 160 and 170, a wireless device 180, and a link 190. The gateway 110 may be a wireless network gateway, a packet network gateway, or any other system or device that provides a gateway for packet data.

The control module 120 may reside within the gateway 110, may be at a service center, may be at a base station, may be at a router, may be at a gateway general packet data service support node, may be independently coupled to the network 140, or may be located anywhere else in the system 100. In operation, the control module 120 can perform a traffic routing function for packet data.

The link information module 130 may be coupled to the control module 120. The link information module 130 may include at least one data connection information table when a data link, such as a primary data link, is established. Information in the link information module 130 can be loaded into the control module 120. The link information module can include one data connection information table for each link established. A data connection table may be a primary link data connection table, a secondary link data connection table, or the like.

The primary link data connection table can include a traffic flow template associated with the primary link such as a primary context. The primary link can be established when a wireless device 180 establishes a communication link with the network 140. The traffic flow template can be used to determine which or how packets are sent over links such as the primary link to the wireless device 180. For example the traffic flow template can be a wireless protocol used to operate a control module, a firewall, a router, or the like. The traffic flow template can be used to block or allow packet data from reaching a location or to route packet data to locations other than a designated location. For example, the traffic flow template may include a list of allowed, blocked, or redirected push proxy gateway addresses. When packet data is received from a specific push proxy gateway address, the packet data is allowed to pass to a wireless device, is blocked from reaching the wireless device, or is redirected to another location depending on the push proxy gateway address designation in the traffic flow template.

The traffic flow template may include packet filters, each identified by a unique packet filter identifier. Each of these filters can contain an evaluation precedence identifier. For example, the traffic flow template may include a source address and subnet mask filter, a protocol number/next header filter, a destination port range filter, a source port range filter, an IPSec filter, a traffic class and mask filter, a flow label filter, an address list filter such as a push proxy gateway Internet protocol address list filter, and additional packet filter elements. The address list filter can include a list including at least one source address or range of addresses. For example, the address list filter may include Internet protocol addresses, universal resource locator data, or any other parameters useful for identifying the source of packet data. The address list filter can identify each address or range of addresses as a block address, an allow address, and/or a redirect address. For example, the address list filter can be used to block packet data received from a block address from being sent over a wireless link to the wireless device 180. The address list filter can also be used to allow packet data received from an allow address to be sent over a wireless link to the wireless device 180. The address list filter can also be used to redirect packet data received from an redirect address to be sent to another link 190 or another device other than the wireless device 180.

The network 140 may include any type of network that is capable of sending and receiving communication signals. For example, the network 140 may include a data network, such as the Internet, an Intranet, a local area network (LAN), a wide area network (WAN), a cable network, and other like communication systems. The network 140 may also include a telecommunications network, such as a local telephone network, a long distance telephone network, a cellular telephone network, a satellite communications network, a cable television network and other like communication systems. Furthermore, the network 140 may include more than one network and may include a plurality of different types of networks. Thus, the network 140 may include a plurality of data networks, a plurality of telecommunications networks, a combination of data and telecommunications networks and other like communication systems.

The wireless support module 150 may include a base station system, a UMTS terrestrial radio access network, or any other system or device that can provide a wireless packet link. The base stations 160 and 170 can provide a wireless connection to the wireless device 180. The wireless device 180 may be a wireless telephone, a cellular telephone, a personal digital assistant, a computer terminal, a pager, a fax machine, an answering machine, an interactive television, or any other device that is capable of sending and receiving wireless data. The link 190 may provide a link to an independent communication system, a cellular communication system, a satellite communications network, a Bluetooth network or device, or any other communication system or device.

In operation according to one embodiment, when the wireless device 180 is powered on, it can determine if it supports an always on mode. If the wireless device 180 supports an always on mode, the wireless device 180 can activate a packet data protocol primary link. In the process of activating the packet data protocol primary link, the wireless device 180 can set a traffic flow template filter at the control module 120 on the packet data protocol primary link. For example, the wireless device 180 can set a filter in the traffic flow template for the control module 120 to control the destination of push messages, packet based data, or any other data that can be filtered using a traffic flow template.

In operation according to another embodiment, the control module 120 can receive an incoming packet message from the network 140 destined for the wireless device 180. The control module 120 can determine if the message matches criteria defined in a traffic flow template or in the link information 130. Depending on how or if the message matches the criteria, control module 120 can forward the message to the wireless device 180, can block the message from reaching the wireless device 180 or can send the message to another link 190 other than the primary link to the wireless device 180.

In operation according to another embodiment, the traffic flow template can be managed by a user of the wireless device 180, by a carrier, or by any other authorized user. For example, the wireless device 180 can send a quality of service modification message to the control module 120. This quality of service modification message can include information for modifying the traffic flow template. As another example, a carrier can modify traffic flow template attributes with a permission set.

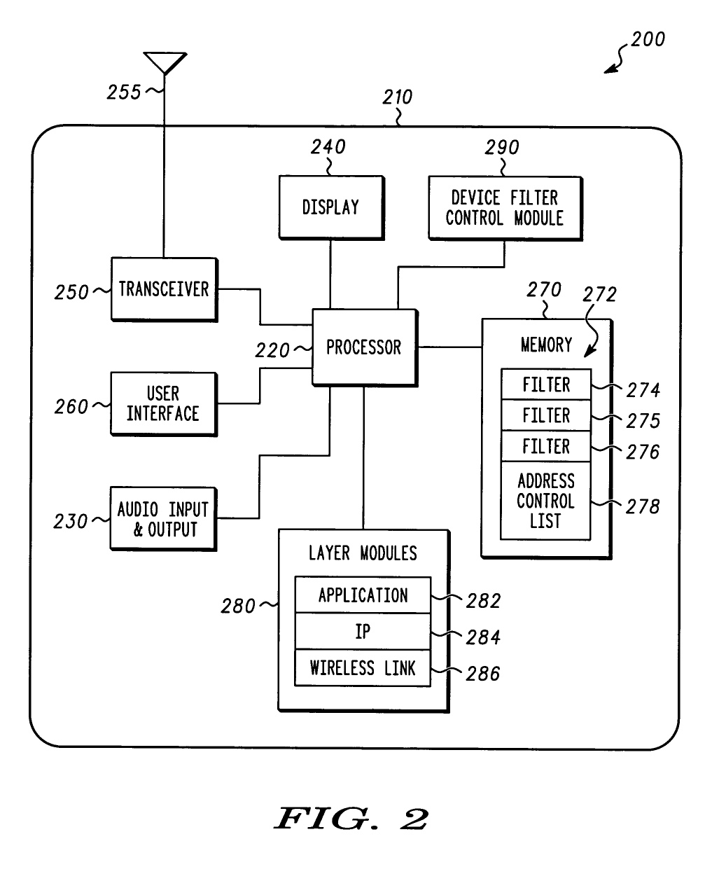

FIG. 2 is an exemplary block diagram of a wireless device 200, such as the wireless device 180, according to one embodiment. The wireless device 200 can include a housing 210, a controller 220 coupled to the housing 210, audio input and output circuitry 230 coupled to the housing 210, a display 240 coupled to the housing 210, a transceiver 250 and an antenna 255 coupled to the housing 210, a user interface 260 coupled to the housing 210, a memory 270 coupled to the housing 210, layer modules 280 coupled to the controller 220, and a device filter control module 290 coupled to the housing 210, the controller 220, and/or the memory 270.

The memory 270 may be a random access memory, a read only memory, an optical memory, a subscriber identity module memory, or any other memory that can be coupled to a mobile communication device. The memory 270 can include a traffic flow template 272, which can include various filters 274-276 and 278 including an address control list 278. The address control list 278 can be used to control how packets of data are filtered based on addresses in the address control list 278. For example, as described above, the traffic flow template 272 may include traffic flow template attributes such as a source address and subnet mask filter, a protocol number/next header filter, a destination port range filter, a source port range filter, an IPSec filter, a traffic class and mask filter, a flow label filter, an address control list 278 such as a push proxy gateway Internet protocol address list filter, and additional packet filter elements. The address control list 278 can include a list including at least one source address or range of addresses. For example, the filter address control list 278 may include Internet protocol addresses, universal resource locator data, or any other parameters useful for identifying the source of packet data. The address control list 278 can identify each address or range of addresses as a block address, an allow address, and/or a redirect address. For example, the address control list 278 can be used to block packet data received from a block address from being sent over a wireless link to the wireless device 200. The address control list 278 can also be used to allow packet data received from an allow address to be sent over a wireless link to the wireless device 200. The address control list 278 can also be used to redirect packet data received from an redirect address to be sent to another link or another device other than the wireless device 200.

The layer modules 280 can include an application layer module 282, an Internet protocol layer module 284, and a wireless link protocol layer module 286. The layer modules 280 can reside in the controller 220, in the memory 270, in the filter control module 290, or anywhere else on the wireless device 200. The wireless link module 286 can handshake with a wireless network to provide a wireless link, context, or communication. The Internet protocol module 284 can route received information to different applications, clients, devices, or the like. The application layer module can provide a web browser, e-mail access, external device or client connections, or other applications.

The controller 220 can control the operations of the wireless device 200. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and a electronic device.

The filter control module 290 can be an independent module, can reside in the controller 220, or can reside within the memory 270. The filter control module 290 can provide traffic flow template filter control operations. According to one embodiment, the filter control module 290 can assist the control module 120 in controlling packet data traffic between a wireless network and a wireless device on a primary link. For example, the filter control module 290 can send a primary packet data protocol link request message including a traffic flow template information element and receive a primary packet data protocol link acknowledgement including an Internet protocol address. The primary packet data protocol link request message can also include an activate packet data protocol context request message identity element and a requested packet data protocol address element.

The traffic flow template information element can include packet filters for controlling how incoming packet data is sent to the wireless device over the primary link based on comparing incoming packet data against the traffic flow template information element packet filters. The traffic flow template information element can further include packet filters for blocking incoming packet data from being sent to the wireless device over the primary link based on comparing an incoming packet data source address against the traffic flow template information element packet filters. The traffic flow template information element can also include packet filters for blocking incoming packet data from being sent to the wireless device over the primary link based on comparing an incoming packet data source address against a range of addresses in the traffic flow template information element packet filters. The traffic flow template information element can additionally include packet filters for allowing incoming packet data to be sent to the wireless device over the primary link based on comparing an incoming packet data source address against the traffic flow template information element packet filters. The traffic flow template information element can further include packet filters for redirecting incoming packet data to a link other than the wireless device primary link based on comparing an incoming packet data source address against the traffic flow template information element packet filters.

Each filter parameter of the primary link traffic flow template filter parameters can include an evaluation precedence identifier. The filter control module 290 can also send a modify primary packet data protocol link request message targeted to a primary packet data protocol link. The modify primary packet data protocol link request message can include a new traffic flow template information element.

The filter control module 290 can also perform uplink packet filtering. For example, the filter control module 290 can block or redirect packets from being sent to the network 140 from the wireless device 200 or from devices connected to the wireless device 200. The filter control module 290 can use the traffic flow template 272 as a filter for this purpose. The controller 220 may also assist in performing or perform the functions of the filter control module 280.

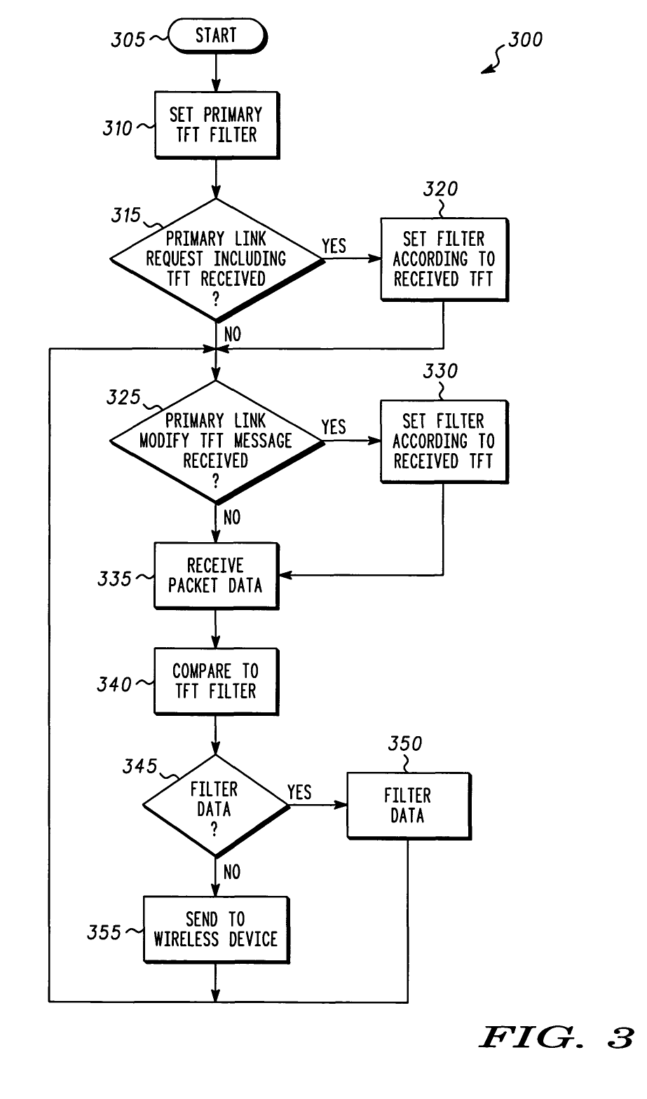

FIG. 3 is an exemplary flowchart 300 outlining the operation of the control module 120 according to one embodiment. In step 305, the flowchart begins. In step 310, the control module 120 sets primary link traffic flow template filter parameters. In step 315, the control module 120 determines if a primary packet data protocol link request message, such as an activate primary packet data protocol context request message, has been received that includes a traffic flow template information element. For example, a primary packet data protocol link request message may be a primary packet data protocol context request message. The primary packet data protocol link request message may be received from the wireless communication device 180 or from another source with the authority to send a primary packet data protocol link request message.

The information elements in a primary packet data protocol link request message can include a protocol discriminator element, a transaction identifier element, an activate packet data protocol context request message identity element, a requested quality of service element, a requested packet data protocol address element, an access point name element, a protocol configuration options element, a traffic flow template element, and/or other elements useful in a primary packet data protocol link request message. The traffic flow template information element can define one or more packet filters.

If a primary packet data protocol link request message including a traffic flow template information element has been received, in step 320 the control module 120 sets the primary link traffic flow template filter parameters according to the received traffic flow template information element. If a primary link request is received that does not include a traffic flow template information element, the control module 120 advances to step 325 without resetting the primary link traffic flow template filter parameters. In step 325, the control module 120 determines if a modify traffic flow template message has been received. The modify traffic flow template message may be a modify packet data protocol context request message that can include a protocol discriminator element, a transaction identifier element, a modify packet data protocol context request message identity element, a requested new quality of service element, a new traffic flow template element, a protocol configuration options element, or other elements useful in a modify packet data protocol context request message. The modify traffic flow template message may be received from the wireless device 180 or from another source with the authority to send a modify traffic flow template message. Thus, the wireless device 180, a network operator, or another source with sufficient authority can set filter information for the wireless communication device 180 at the control module 120. Therefore, as discussed below, incoming packet data traffic can be verified against this filter information and selective handing can be performed at the network instead of the wireless device 180 to allow greater security and radio resource optimization.

If a modify traffic flow template message has been received, in step 330 the control module 120 modifies the primary link traffic flow template filter parameters according to the received new traffic flow template information element. If not, in step 335, the control module 120 receives packet data. In step 340, the control module 120 controls how the incoming packet data is sent to the wireless device 180 based on comparing the incoming packet data against the primary link traffic flow template filter parameters. For example, the filter parameters may include Internet protocol addresses, universal resource locator data, or any other parameters useful for identifying the source of packet data. If the result of the comparison is to filter the packet data, in step 350 the control module 120 filters the packet data. If the result of the comparison in step 345 is to not filter the packet data, in step 355, the control module 120 sends the packet data to the wireless device 180.

For example, the control module 120 can block the incoming packet data from being sent to the wireless device 180 based on a packet data source address being listed as a disallowed source address in the traffic flow template filter parameters. The control module 120 may alternately block the incoming packet data from being sent to the wireless device 180 based on a packet data source address being listed in a range of disallowed data source addresses in the traffic flow template filter parameters. The control module 120 may alternately block the incoming packet data from being sent to the wireless device 180 based on a packet data source address not being listed as an allowed source address in the traffic flow template filter parameters. The control module 120 may alternately block the incoming packet data from being sent to the wireless device 180 based on a packet data source address not being listed in a range of allowed data source addresses in the traffic flow template filter parameters. The control module 120 may alternately redirect the incoming packet data from being sent to the wireless device 180 on a primary link based on a packet data source address being listed as a redirection source address in the traffic flow template filter parameters. For example, the control module 120 may redirect the incoming packet data to another link, to another device, or to any other appropriate destination. When packet data is blocked or redirected, the control module 120 may send a message informing the wireless device 180 of the action taken. The wireless device 180 may then modify the traffic flow template filter if a different course of action is desired in the future.

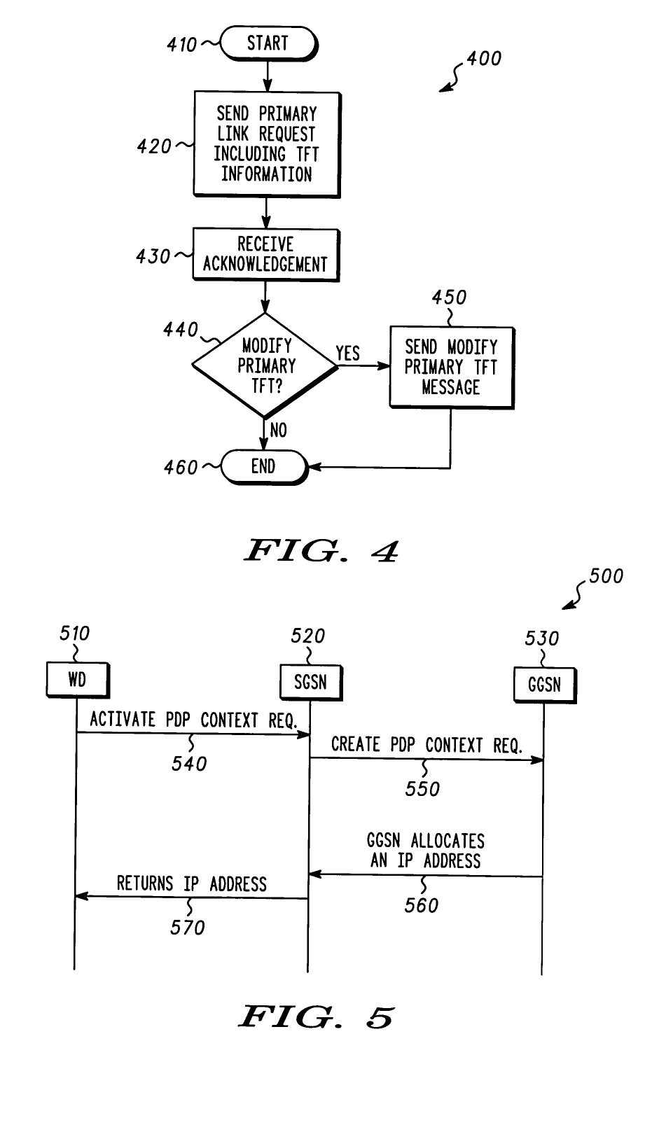

FIG. 4 is an exemplary flowchart 400 outlining the operation of the controller 220 or the filter control module 290 according to another embodiment. In step 410, the flowchart begins. In step 420, the filter control module 290 can send a primary link request including traffic flow template information. In step 430, the filter control module 290 can receive an acknowledgement of a primary link being established. In step 440, the filter control module 290 can determine if the primary link traffic flow template should be modified. If so, in step 450, the filter control module 290 sends a modify primary link traffic flow template message. In step 460, the flowchart ends.

FIG. 5 is an exemplary message flow diagram 500 according to one embodiment. The flow diagram 500 illustrates messages sent between a wireless device 510 such as the wireless device 180 and a serving global packet radio service support node (SGSN) 520 and a gateway global packet radio service support node (GGSN) 530 located on a network such as the network 140. In step 540, the wireless device sends an activate packet data protocol link request such as an activate packet data protocol context request to the SGSN 520. The activate packet data protocol link request can include a traffic flow template information element. In step 550, the SGSN 520 can send a create packet data protocol link request such as a create packet data protocol context request to the GGSN 530. In step 560, the GGSN 530 can allocate an Internet protocol address and forward it to the SGSN 520. In step 570, the SGSN 520 can return a primary packet data protocol link acknowledgement including the Internet protocol address to the wireless device 510.

The method of this invention is preferably implemented on a programmed processor. However, the control module 120, the filter control module 290 and/or the controller 220 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

1. A method of controlling packet data traffic between a wireless network and a wireless device on a primary link, the method comprising:
setting primary link traffic flow template filter parameters at a packet control module;
comparing incoming packet data against the primary link traffic flow template filter parameters; and
controlling how the incoming packet data is sent to the wireless device over the primary link based on comparing incoming packet data against the primary link traffic flow template filter parameters.

2. The method according to claim 1, further comprising receiving a primary packet data protocol link request message including a traffic flow template information element,
wherein setting further comprises setting primary link traffic flow template filter parameters based on the received traffic flow template information element.

3. The method according to claim 1, wherein controlling comprises blocking the incoming packet data from being sent to the wireless device based on a packet data source address being listed as a disallowed source address in the traffic flow template filter parameters.

4. The method according to claim 1, wherein controlling comprises blocking the incoming packet data from being sent to the wireless device based on a packet data source address being listed in a range of disallowed data source addresses in the traffic flow template filter parameters.

5. The method according to claim 1, wherein controlling comprises blocking the incoming packet data from being sent to the wireless device based on a packet data source address not being listed as an allowed source address in the traffic flow template filter parameters.

6. The method according to claim 1, wherein controlling comprises blocking the incoming packet data from being sent to the wireless device based on a packet data source address not being listed in a range of allowed data source addresses in the traffic flow template filter parameters.

7. The method according to claim 1, wherein controlling comprises redirecting the incoming packet data from being sent to the wireless device on a primary link based on a packet data source address being listed as a redirection source address in the traffic flow template filter parameters.

8. The method according to claim 1, wherein the network gateway comprises a gateway general packet radio service support node.

9. The method according to claim 1, further comprising receiving a primary packet data protocol link request message including a traffic flow template information element, a activate packet data protocol context request message identity element, and a requested packet data protocol address element,
wherein setting further comprises setting primary link traffic flow template filter parameters based on the received traffic flow template information element.

10. The method according to claim 1, wherein each filter parameter of the primary link traffic flow template filter parameters include an evaluation precedence identifier.

11. The method according to claim 1, further comprising:
receiving a modify primary packet data protocol link request message, the modify primary packet data protocol link request message including a new traffic flow template element; and
modifying the primary link traffic flow template filter parameters based on the new traffic flow template element.

12. A method in a wireless device of controlling packet data traffic between a wireless network and a wireless device on a primary link, the method comprising:
sending a primary packet data protocol link request message including a traffic flow template information element; and
receiving a primary packet data protocol link acknowledgement including an Internet protocol address.

13. The method according to claim 12, wherein the primary packet data protocol link request message also includes an activate packet data protocol context request message identity element and a requested packet data protocol address element.

14. The method according to claim 12, further comprising sending a modify primary packet data protocol link request message targeted to a primary packet data protocol link, the modify primary packet data protocol link request message including a new traffic flow template information element.

15. The method according to claim 12, wherein the traffic flow template information element includes packet filters for controlling how incoming packet data is sent to the wireless device over the primary link based on comparing incoming packet data against the traffic flow template information element packet filters.

16. The method according to claim 12, wherein the traffic flow template information element includes packet filters for blocking incoming packet data from being sent to the wireless device over the primary link based on comparing an incoming packet data source address against the traffic flow template information element packet filters.

17. The method according to claim 12, wherein the traffic flow template information element includes packet filters for blocking incoming packet data from being sent to the wireless device over the primary link based on comparing an incoming packet data source address against a range of addresses in the traffic flow template information element packet filters.

18. The method according to claim 12, wherein the traffic flow template information element includes packet filters for allowing incoming packet data to be sent to the wireless device over the primary link based on comparing an incoming packet data source address against the traffic flow template information element packet filters.

19. The method according to claim 12, wherein the traffic flow template information element includes packet filters for redirecting incoming packet data to a link other than the wireless device primary link based on comparing an incoming packet data source address against the traffic flow template information element packet filters.

20. The method according to claim 12, wherein each filter parameter of the primary link traffic flow template filter parameters include an evaluation precedence identifier.

21. A network gateway, comprising:
a packet data protocol primary link information module, the packet data protocol primary link information module including traffic flow template information related to controlling which packets of data are sent to a wireless device on a primary link; and
a traffic flow template packet control module coupled to the packet data protocol primary link information module, the traffic flow template packet control module configured to control which packets of data are sent to a wireless device on the primary link based on the traffic flow template information.

22. The network gateway according to claim 21, wherein the traffic flow template information includes at least one disallowed address for blocking packets of data received from the at least one disallowed address and allowing packets of data from other addresses to be sent to the wireless device.

23. The network gateway according to claim 21, wherein the traffic flow template information includes at least one range of addresses for controlling the routing of packets of data received from the at least one range of addresses.

24. The network gateway according to claim 21, wherein the traffic flow template information includes at least addresses the at least one address comprising at least one of a universal resource locator address and an Internet protocol address.

25. The network gateway according to claim 21, wherein the traffic flow template packet control module is further configured to receive a primary packet data protocol link request message including a traffic flow template information element and set the traffic flow template information based on the received traffic flow template information element.

26. The network gateway according to claim 21, wherein the traffic flow template packet control module is further configured to receive a primary packet data protocol link modify message including a new traffic flow template information element and set the traffic flow template information based on the new traffic flow template information element.
